(19) United States
(12) Patent Application Publication
(10) Pub. No.: US 2020/0349550 A1
(43) Pub. Date: Nov. 5, 2020

(54) METHOD AND SYSTEM FOR AUTHORIZING A TRANSACTION

(71) Applicant: Surfboard Payments AB, Uppsala (SE)

(72) Inventors: Neal HINDOCHA, Bunkeflostrand (SE); Christopher LINDFELDT, Solna (SE)

(73) Assignee: Surfboard Innovations AB, Solna (SE)

(21) Appl. No.: 16/092,297

(22) PCT Filed: Apr. 12, 2017
(86) PCT No.: PCT/SE2017/050371

§ 371 Date: Oct. 9, 2018

(30) Foreign Application Priority Data
Apr. 12, 2016 (SE) 1650496-1

(51) Int. Cl. G06Q 20/32; G06Q 20/08; G06Q 30/02

(52) U.S. Cl. CPC G06Q 20/3276; G06K 7/1417; G06Q 30/0226; G06Q 20/085

(57) ABSTRACT

Method for authenticating a transaction, wherein a first transaction party uses a first electronic device (310,320) with a screen display (311,321) and a second transaction party uses a second, portable, electronic device (410) with a camera. The invention is characterised in the steps a) associating the transaction with the first device and providing there to transaction information; b) displaying, on the screen display, visually coded information identifying the transaction; c) capturing, using the camera, an image of the screen display, which image comprises said coded information and at least a portion of the first device outside of the screen display; d) based upon the captured image, decoding and interpreting said coded information and identifying a piece of first device hardware; e) verifying that the transaction identified by the coded information is associated with the first device, based upon the identified piece of hardware. The invention also relates to a system.

The present invention relates to a method and a system for authorizing a transaction. In particular, the invention relates to such a transaction performed by a user using a physical point of sale within which the user is in physical proximity in connection to said transaction.

In many situations, a physical point of sale is used for performing a transaction. Examples of such physical points of sale comprise a conventional plastic card reader, such as a wired or wireless combined card reader and PIN code keyboard connected to a cashier in a store or a restaurant; a vending machine or other goods-dispensing piece of equipment with a built-in card reader; or a card reader connected by wire or wirelessly to a general-purpose computer device such as a tablet computer.

Herein, for reasons of simplicity, a holder of such a physical point of sale, which holder may be a vendor or any other party taking part in a transaction as a first transaction part, is called a “vendor”. For similar reasons, another, a second, transaction party, interacting with the vendor's physical point of sale as a step in the transaction process, is called a “user”.

Such physical points of sale can be used for various types of transactions, notably for a vendor of some sort to receive payment for a product, such as a good or a service, from a user in the form of a buying customer. In order for such a transaction to be processed, the transaction must at some time be authorized. This is true for transactions conducted at points of sale used for receiving money payments, but is equally true for other transactions in which a physical point of sale is used. Examples comprise transactions comprising an identification of a user, via the physical point of sale, with respect to a vendor or a third party; and various types of agreements entered into by a user, via a physical point of sale, in relation to a vendor or a third party.

For all such transactions, the authorization of the transaction poses numerous problems, where the basic problem is that the transaction parties must be able to trust one another, and to keep unauthorized third parties from capturing sensitive information regarding the parties or the transaction as such.

For instance, the vendor must be able to trust that the user is authorized to enter the transaction as a first transaction party, for instance the user may have to be securely identified by the vendor or a central party. This may conventionally take place by showing a piece of ID. The vendor must also be able to trust that a payment means, such as a credit card, presented by the user can be validly used by the user. For example, the user could try to unlawfully use someone else's credit card.

Furthermore, the user must be certain that a particular vendor is valid, for instance that no skimming equipment has been planted on the physical point of sale.

Also, a central party, such as a payment network or a transaction switch, must be able to know that both parties can be securely identified and tied to the transaction.

Finally, neither the vendor, nor the user or any central party, must run the risk of confidential or sensitive information, or money or any other subject of the transaction, pertaining to the party or transaction unlawfully ending up in the hands of a third party. For instance, skimming, phishing or man-in-the-middle attacks must be avoided.

At the same time, user experience is of critical importance. Safety measures that are seen as too cumbersome will often lead to the transaction not taking place at all, since users become increasingly sensitive to such measures.

Many attempts have been made at solving these issues. For instance, it has been proposed to use the SMS (Short Message Service) channel to securely identify a cell phone belonging to the user. Similarly, several NFC-based (Near Field Communication) solutions have been presented. This way, the something-you-have factor which is the cell phone itself is exploited with respect to the user. Other examples of previous attempts include the digital image registration of a piece of identification presented by the user at a physical point of sale.

Exemplifying prior art documents describing solutions involving a physical point of sale and a user with a mobile device include U.S. Pat. No. 8,380,177 B2, US 2011251910 A1 and CN 104123647 A.

The Swedish patent application with application number 1551320-3, which has not been published at the time of filing of the present application, describes a method according to which a physical item identifying piece of information is associated, in a central server, with payment card information pertaining to a payment card which has previously been read from a physical payment card at a physical point of sale, and according to which method said physical item can be used instead of the payment card to make payments.

The present invention solves the above identified problems.

Hence, the invention relates to a method for authenticating a transaction, wherein a first transaction party uses a first electronic device for performing said transaction and a second transaction party uses a second, portable, electronic device for performing said transaction, which first device comprises a screen display and which second device is a general-purpose programmable device comprising a digital camera, which method is characterised in that the method comprises the steps of a) associating the transaction with the first device and providing, to the first device, information regarding the transaction; b) displaying, on the screen display, visually coded information identifying the transaction; c) capturing, using the digital camera, an image of the screen display, which image comprises said visually coded information as well as at least a portion of the first device which portion lies outside of the screen display; d) decoding and interpreting said visually coded information, based on the captured image, and further identifying a piece of hardware pertaining to the first device also based upon the same captured image; e) verifying that the transaction identified by the visually coded information is associated with the first device, based upon the identified piece of hardware.

Furthermore, the invention relates to a system for authenticating a transaction, wherein a first transaction party uses a first electronic device for performing said transaction and a second transaction party uses a second, portable, electronic device for performing said transaction, which first device comprises a screen display and which second device is a general-purpose programmable device comprising a digital camera, which system comprises a first transaction software function arranged to be executed on or from the first device or a control device arranged to control the screen display; a second transaction software function arranged to be executed on or from the second device; and a central server in communication with said first and second software functions, which system is characterised in that the central server is arranged to associate the transaction with the first device; in that the first software function is arranged to display, on the screen display, visually coded information identifying the transaction; in that the second software function is arranged to capture, using the digital camera, an image of the screen display, which image comprises said visually coded information as well as at least a portion of the first device which portion lies outside of the screen display; in that the second software function and/or the central server is arranged to decode and interpret said visually coded information, based on the captured image, and further to identify a piece of hardware pertaining to the first device also based upon the same captured image; and in that the central server is arranged to verify that the transaction identified by the visually coded information is associated with the first device, based upon the identified piece of hardware.

In the following, the invention will be described in detail, with reference to exemplifying embodiments of the invention and to the enclosed drawings, wherein:

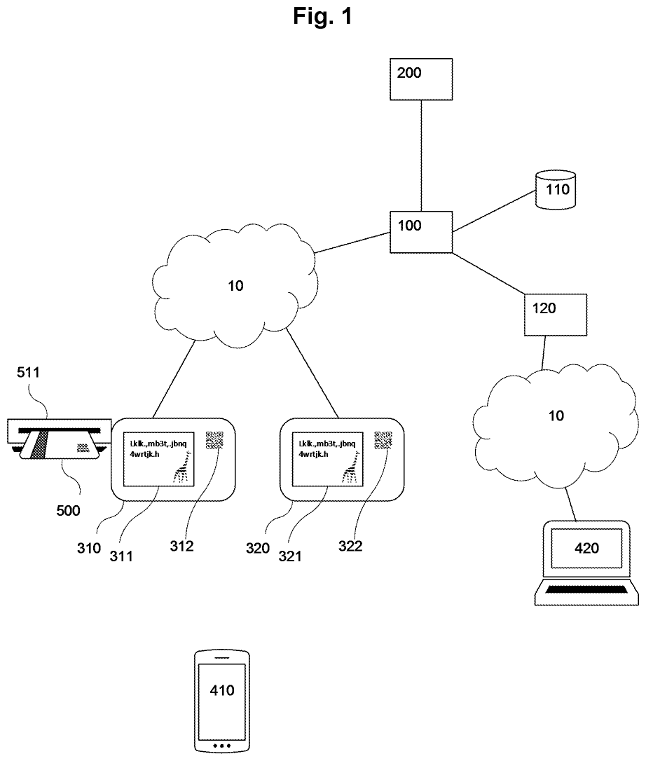

FIG. 1 is an overview illustration of a system according to the present invention;

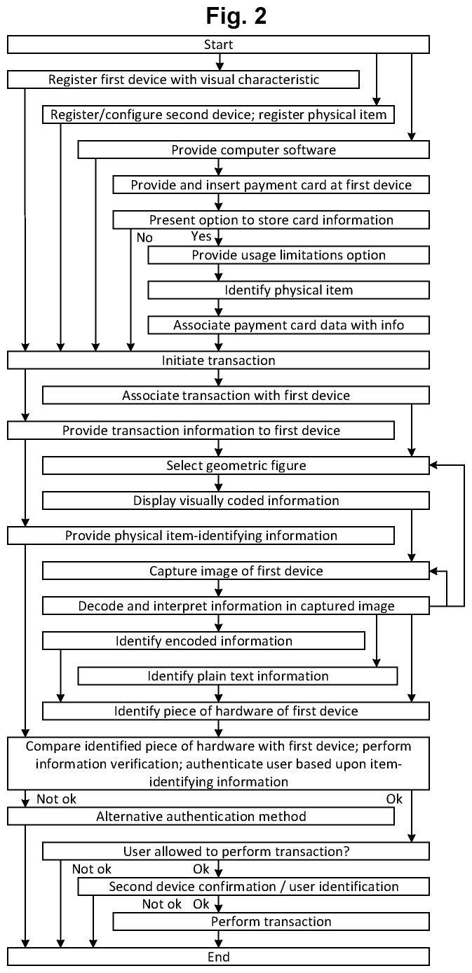

FIG. 2 is a flow chart illustrating a method according to the present invention; and

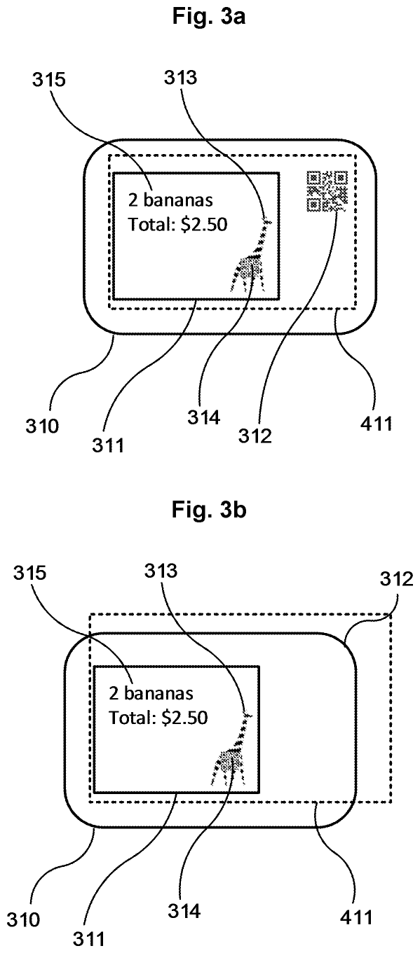

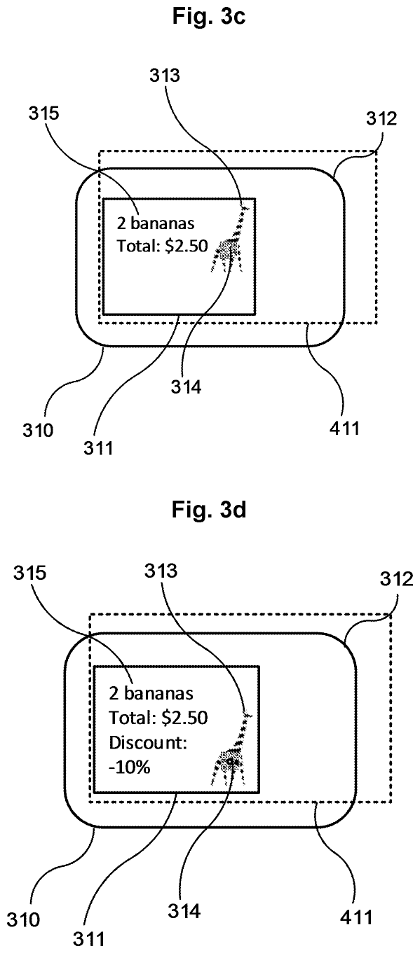

FIGS. 3a-3d are respective views of a first electronic device according to various preferred embodiments of the present invention.

All figures share the same reference numerals for the same or corresponding parts.

FIG. 1 illustrates a system arranged to perform a method according to the present invention for authorizing an electronic payment. The system at least comprises a central server 100, in turn comprising or being connected to a database 110. Preferably, the system also comprises a web server 120 or other user interface providing device, arranged to provide an interface to a user of the present method using which the user, via a computer 420 and over a secure communication line such as an encrypted internet 10 connection, can administer and configure user-specific information, such as registered payment cards; rules applicable to the use of such payment cards, interactions with particular vendors or points of sale, purchases of particular goods or services, etc.; bank account information; and so forth. Hence, one user may interact with the system, such as making, viewing or adjusting such settings for him- or herself or for one or several particular other users, via the user interface-providing device 120.

The central server 100 may be implemented as one standalone physical server and/or logical server instance, or may be distributed across several, interconnected such physical and/or logical server instances, as is conventional as such for servers in general. The web server 120 may be an integrated part of the central server 100 or a standalone server. The corresponding is true regarding the database 110.

The server 100 and the web server 120 are preferably connected to the internet 10 for communication with at least one, preferably a plurality, of points of sale 310, 320. Such a point of sale is preferably a physical point of sale, which may comprise, or be in secure communication with a conventional payment card reader 511, such as a conventional, physical payment card reader, of the type which is today present in most physical points of sale, such as in stores and service outlets. Examples of payment card readers comprise those arranged to read a magnetic strip and/or an electronic circuit of a payment card and thereby receive information from the payment card, and those that are arranged to read information from a payment card via a wireless communication technique, such as NFC.

A “payment card”, as used herein, refers to a physical payment card arranged to be read by such a payment card reader 511. Hence, the payment card has a standardized size and shape, and comprises a magnetic strip; an electronic circuit; an NFC means; and/or other conventional means for communicating with such a payment card reader and thereby provide payment card information to the payment card reader. Examples of such payment cards comprise bank and credit cards and also customer loyalty- and membership cards and similar. In all cases, such a payment card is associated with a payment channel, so that the mentioned payment card information, stored on the payment card, provides access to a payment service.

FIG. 1 further illustrates a portable electronic device, 410 exemplified by a general-purpose programmable mobile telephone. The phone has at least one wireless digital communication capability, using which digital information can be transmitted to a receiver. One example of such capability is a mobile telephony communication ability, such as a GPRS, 3G, 4G or LTE, or a WiFi capability, using which the second device 410 can communicate digitally with other internet 10 connected devices. The second device 410 may also have close-range communication capabilities, such as via NFC, Bluetooth® or similar, arranged to provide local wireless communication to locally arranged devices.

Specifically, according to the invention a first transaction party uses a first electronic device, namely the point of sale 310 and/or 320, for performing a particular transaction. The first transaction party may be a vendor, such as a physical store, but may be any other type of party, such as an automatic vending machine-operating party or a parking meter-operating party. Typically, the first transaction party (the vendor) will control, such as own, the point of sale 310, 320. For instance, the point of sale 310, 320 may be a permanently installed part of the vendor's physical store och larger premises or point of sale.

Similarly according to the invention, a second transaction party (the user) uses a portable second electronic device 410, such as the phone shown in FIG. 1, for performing the said same transaction.

Herein, a “transaction” can be any type of transaction, such as a transfer of money, for instance in the form of a payment for a product; an agreement; a login; and so on. What is important is that both the first and the second transaction parties join as parties to one common transaction, which common transaction is the transaction according to the present invention.

The first device 310, 320, comprises a respective screen display 311, 321, which is controlled by the first device 310, 320 itself or a control unit in turn controlling the point of sale 310, 320, preferably in a way so that arbitrary information can be shown on said screen 311, 321. Preferably, the screen display 311, 321 is a conventional pixel-based screen display which is capable of showing arbitrary imagery by setting respective pixels to corresponding values. The screen display 311, 321 may be a colour display, but may also be a black-and-white display.

The second device 410 is a general-purpose programmable device, in other words a device on which externally provided software applications can be installed and executed, or which is capable of executing remotely accessed software applications, such as accessed via a HTML v.5 web page or a web service. Typically, the second device 410 is a conventional “smartphone”. The second device 410 comprises a digital camera, which preferably is capable of capturing not only still images but also a film sequence. Typically, such images or films are stored on a local RAM memory in the second device 410, but they can also be live streamed to the central server 100 via internet 10 or first stored in local RAM in the second device 410 and thereafter sent to the central server 100.

FIG. 2 illustrates a method in accordance with the present invention. In an initial step, the method starts, after which a number of initiation steps are taken in any order.

The following description focuses on the method steps of a method according to the present invention. It is, however, realized that the invention equally well covers the system illustrated in FIG. 1, arranged to perform the method steps as described below. In particular, the system in a preferred embodiment comprises the central server 100 and the below-described first and second computer software functions.

In one preferred such initiation step, the first device 310, 320 is registered with the central server 100 as a point of sale of a potential first transaction party in the sense of the present invention, ready to take part in a transaction. In this step, at least a visual characteristic (a piece of hardware), as discussed below, is registered by the central server 100 for the first device 310, 320, for instance by storing the corresponding association in the database 110.

In another preferred such initiation step, the second device 410 is registered, in a similar manner, with the central server 100 as a portable electronic device of a potential second transaction party in the sense of the present invention, ready to take part in a transaction.

In another preferred such initiation step, suitable computer software is provided to the first device 310, 320 and/or to the second device 410. With respect to the first device 310, 320, a first computer software product or function is provided, which is executable or from the first device 310, 320, such as on hardware comprising the screen display 311, 321 or on a control device arranged to control what is displayed on the screen display 311, 321. Preferably, there are no unencrypted logical connections between the first computer software function and external systems. One such encrypted connection is to the central server 100, with which the first computer software product is preferably connected via the internet 10. With respect to the second device 410, a second computer software function or product is provided, which is executable on or from the second device 410, such as a software application installed on the second device 410 or a remote software service accessible from the second device 410 from the second device 410.

Preferably, the user must sign up for a user account, using the second device 410 and preferably in relation to the central server 100, in an installation/configuration step. This step preferably results in that the second device 410 is unambiguously and securely tied to the user, for instance by the user being securely identified to the central server 100 during configuration of the first software function, and the software function being securely tied to the mobile device 410 as such. Such installation and configuration is conventional as such, and is not described in further detail herein. This step may also involve registering a physical item with wireless nearfield communication capabilities to be used for authenticating the user at the time for the actual performance of the transaction, as described below.

The method steps according to the present invention described below are preferably performed by the first and second computer software products, cooperating with each other and with the central server 100 so as to perform the method.

Then, the transaction is initiated. This may take place in any suitable way, such as on the initiative of a point of sale personnel (in case the point of sale is manned), or on the initiative of the user (in case the point of sale is unmanned).

As a result of the transaction initiation, or in a separate step, the transaction is associated with the first device 310, 320. This association may be stored in a memory in the first device 310, 320 itself and/or in the central server 100, and identifies the first device 310, 320 as a first device which is to be used in the identified transaction in question. For instance, this may involve a point of sale personnel or the user selecting products to be purchased, such as by scanning corresponding barcodes on such products; the first device 310, 320 obtaining, from a local database, from the central server 100 or from any suitable source, corresponding product descriptors and amounts to be paid for the products in question; and associating the first device 310, 320 with the hence defined transaction. From this point on, the system, and preferably the central server 100 or the database 110, comprises associative information tying the first device 310, 320 to the specific transaction in question.

As a part of this step, or in a separate subsequent step, information (such as the one mentioned regarding the scanned products) regarding the transaction is provided to the first device 310, 320. In a preferred product purchasing embodiment, this information comprises at least information regarding a product or quantity of a product or service to purchase, or a price of a product or service to purchase.

In a subsequent step, visually coded information identifying the transaction is displayed on the screen display 311, 321 of the first device 310, 320. Herein, “visually coded information” means any information which is coded in a visually readable way on the screen display 311, 321 in an unambiguous way. Examples include plain alphanumeric text; a conventional QR code; a barcode; or any other predetermined information coding manner allowing a party viewing the screen display 311, 321 to interpret the visible coded information. Furthermore, that the information “identifies the transaction” means that the information is sufficient to unambiguously identify a particular transaction, in light of the context in which the information is displayed. For instance, the information may comprise an unambiguous transaction identifier, such as a transaction serial number; or the information may comprise information about a number of products to be purchased, for instance in combination with a price to be paid for each product and/or in total.

More broadly, the visually coded information preferably comprises at least one of a transaction identifier; information describing the subject of the transaction; a time stamp; a random/cryptographic key; and a first 310, 320 and/or second 410 device identifier. Such a random key can be used as a one-time password (OTP) between the first 310, 320 and the second 410 device, further improving security. A cryptographic key can be used as a part of an encryption scheme applied to the communication between the second device 410 and the central server 100, and may be provided from the central server 100 to the first device 310, 320 prior to being transferred to the second device 410 as a part of the visually coded information.

Once the OTP has been received by the second device 410, it can be used to encrypt or verify communications between the central server 100 and the second device 410 to increase security, not least make it difficult to eavesdrop such communication. In particular, this provides a way to substantially increase security based upon the very limited typical bandwidth of the image-based communication channel between the first device 310, 320 screen 311, 321 and the second device 410.

The OTP may be used as a password in a PAKE-type protocol, as a password. The registered userID is the username component for the PAKE protocol. By using a PAKE protocol, an eavesdropper or man in the middle cannot obtain enough information to be able to brute force guess a password without further interactions with the parties for each (few) guesses. This means that strong security can be obtained using weak passwords, meaning that a short password transferred from the visually encoded information to the mobile device vastly increases the security.

The cryptographic keys that are the result from the PAKE protocol can be used to either encrypt the data sent from the mobile device to the server, or used as a key in a HMAC to secure the integrity of the transaction.

Preferably, all communications between the second device 410 and the central server 100 after the transfer of the OTP via the captured image takes place over an communication channel which is encrypted using said OTP.

In a subsequent step, the digital camera of the second device 410 is used to capture a digital image of the screen display 311, 321 of the first device 310, 320. The camera may be automatically activated by the second software function.

Preferably, the image comprises a large enough portion of the screen display 311, 321 so that the visually coded information can be read from the image to an extent allowing the transaction to be uniquely identified, preferably at least by the central server 100. This may, for instance, mean that transaction details (product quantities and prices) may not be visible in the image whereas a QR code or a plain text snippet with a transaction identifier is visible; that the entire screen display 311, 321 is visible; and so on.

According to the invention, however, the captured image comprises said visually coded information as well as at least a portion of the first device 310, 320, which portion lies outside of the screen display 311, 321 of the first device 310, 320. In other words, the image covers at least a part of the first device 310, 320 apart from its screen display 311, 321. To what extent such a non-screen display portion is visible in the captured image may vary, as long as the below-described identification is possible to perform in an unambiguous manner, based upon the captured image.

The captured image is preferably stored in the second device 410, such as on a RAM memory of the second device 410.

In a next step, the said visually coded information is decoded and interpreted, based upon the captured image. Such decoding and interpreting can be performed by the first device 410 or the central server 100, as described below, and may employ conventional digital image analysis and recognition methods, such as OCR, in a number of steps such as a visually coded information identification and localization step; a visually coded information decoding step (for instance reading the information contents of an identified QR code); and a visual identification interpretation step (for instance, extracting transaction-identifying information from the decoded QR code). The result of this decoding and interpretation is preferably that the visually coded transaction-identifying information is available to the system, such as to the second device 410 or to the central server 100.

Further according to the present invention, said captured image is analysed so as to identify a visual characteristic or piece of hardware pertaining to the first device 310, 320, which analysis is also based upon the same captured image. This identification, which is preferably based upon the part of the image depicting the said portion of the first device 310, 320 lying outside of the screen display 311, 321, is exemplified below. The hardware identification may also be based upon conventional image processing techniques, for instance comprising a step in which a part of the captured image comprising a depiction of a part of the hardware; followed by a step in which the depicted hardware is analysed and identified against predetermined information in a database.

Then, in a subsequent step, it is verified that the transaction identified by the visually coded information is associated with the first device 310, 320, based upon the identified piece of hardware. In other words, the first device 310, 320 is identified based upon the said identified piece of hardware belonging to the first device 310, 320, and possibly further based upon a previously stored association between hardware information and the first device 310, 320, and then it is verified that the first device 310, 320 is indeed associated with the particular transaction in question. This verification, as all verifications described herein, is preferably performed by the central server 100.

Finally, if the said verification turns out in the positive, the transaction is preferably performed. For instance, money may be transferred or debited as a payment for products; the user may be authenticated; and so on. In case the verification fails at any point, the transaction is preferably not performed. Instead, the user may then instead be provided with an alternative, conventional, authentication means with respect to the transaction.

The performance of the transaction is preferably based at least partly upon the visually coded information, at least such that information being part of the visually coded information (for instance, the total amount to be paid in a purchase transaction, or an identifier of a service to log into in a login transaction) is information necessary for performing the transaction.

Such a method, and such a system, achieves that a very high level of security is achieved without the vendor or the user having to partake in complicated or complex steps. The user can simply activate a software function on the mobile device 410, direct the device 410 towards the point of sale 310, 320 and capture a single image thereof. After that, the entire process can be performed automatically. The point of sale 310, 320, after registering particulars regarding its hardware appearance, can essentially be used as before, without any modifications.

Since the mobile device 410 of the user is used to capture the image, the system can be certain that the mobile device 410, which is tied to the user, is locally present at the site for the point of sale 310, 320. The transaction identifying visually coded information can be designed so as to be difficult to spoof. Since the actual hardware of the point of sale 310, 320 is identified and verified at the same time (in the same image) as the visually coded information), a very strong local presence guarantee can be achieved for the mobile device 410, effectively proving that it is actually the particular intended first party which in fact interacts with the particular intended second party. By a simple encryption of communication between the mobile device 410 and the central server 100, man-in-the-middle attacks can be prevented.

Furthermore, skimming attacks can be prevented. In a particularly preferred embodiment, the physical part of the first device 310 which is used to identify the piece of hardware is located in the vicinity of the card reader 311, specifically covering an area around the card 500 insertion point which is typically affected by skimming equipment mounted on the reader 311. This will result in that the hardware is not correctly identified (it does not visually look as it is supposed to), and as a result that the transaction is not completed.

It is in general preferred, in the present invention, that the central server 100 is used to perform at least a subset of the above described steps, and also to actually authorize or perform the transaction in question. Preferably, the central server 100 communicates directly with both the first 310, 320 and the second 410 devices, based upon secure (such as encrypted and trusted) communication channels in turn based upon previously registered user/vendor accounts on the central server 100. The central server 100 is preferably in communication with a third party 200, such as a financial institution, for actually performing the transaction in term of transferring money and so on.

In one embodiment, the above discussed association between the transaction and the first device 310, 320 is made in the central server 100 or in the database 110, such as on the initiative of the first device 310, 320 or the first transaction party. This step is preferably taken in immediate connection to the transaction, preferably as the result of an interaction between the first 310, 320 and second 410 devices, as a result of which interaction (for instance, a user self-scanning of products at a grocery store) the transaction itself is defined. Further preferably, the central server 100 is in this case involved in the above discussed decoding and/or interpretation of the visually coded information and/or the piece of hardware. For instance, information comprising or corresponding to the visually coded information and/or the identified piece of hardware may be sent from the second device 410 to the central server 100 for verification. Alternatively, information corresponding to or comprising the said captured image may be sent to the central server 100 for both interpretation and verification. In the latter case, the central server 100 comprises image analysis software to perform the above-described decoding and/or interpretation. The process may be interactive between the second device 410 and the central server 100, such as the central server 100 providing feedback to the second device 410 regarding the success of said decoding, interpretation and/or verification for the user to see.

In particular, it is preferred that the second device 410 allows the second party to confirm transaction information on a screen display comprised in the second device 410 before the transaction is finally authorized. This confirmation may be performed using an interactive graphical user interface provided by the said first software function. Preferably, the “transaction information” to be confirmed is information which is sufficiently detailed for the user to be able to unambiguously identify the particular transaction based upon the information to be confirmed. For instance, the information to be confirmed comprises at least part of the information contents of the said visually coded information. The confirmation may be a simple “yes” or “no” from the user, or the user being required to enter a PIN code, or similar, for extra security.

Preferably, the transaction information to be verified by the user is sent from the first device 310, 320 to the central server 100, via said secure channel, and thereafter from the central server 100 to the second device 410, again via a secure channel, before said transaction information confirmation step. This way, no direct, interceptable communication of potentially sensitive information takes place directly between the parties.

Further preferably, the user (the second transaction party) is identified using the second device 410 before the transaction is finally authorized. This may, for instance, take place by the user entering said PIN code into the said mobile device 410 user interface, by a biometric information being read from the user's body by the mobile device 410, and so on. Preferably, the central server 100 initiates or requests such user identification, preferably via the said second software function. Alternatively, the central server 100 may extract information regarding the identity of the user based upon the identity of the second device 410 and a previously stored association, such as in database 110, between users and first devices.

In particular in the latter case, it is preferred that, before the above described user confirmation is performed, or at least before the transaction is finally authorized, the transaction (that is, the contents of the transaction) is adjusted, such as in terms of price to be paid; payment method to use; or points to be awarded a customer loyalty program as a consequence of a purchase. This adjustment may, for instance, be performed as a result of a particular combination of one or several of the particular user in question; the particular point of sale in question; the contents of the transaction itself; time of day; contractual relationships; and so forth. In particular, the said user confirmation is preferably performed with respect to the adjusted transaction. This way, a discount or special promotion offer can automatically be added to a purchase or the like and approved by the user, on the fly and as a direct consequence of the initiation of the transaction itself. Since the conditions for this can be specified in or for the central server, the vendor can use this functionality even at unmanned points of sale.

For instance, this functionality can be also used to control purchasing behaviour of individual users, such as a parent controlling what products a child is allowed to purchase using a line of credit tied to the child's smartphone. More broadly speaking, it is preferred that the central server 100, based upon said identification of the second transaction party and previously stored information relating to the second transaction party available to the central server 100, verifies that the second transaction party is entitled to take part in the transaction using the first device 310, 320 and/or in relation to the first transaction party. This verification preferably takes place before a user confirmation step, if used, or at least before the transaction is finally authenticated.

As mentioned above, there is preferably a first transaction software function, which is executed on or accessible from the first device 310, 320 and which preferably performs all, or at least some, of the method steps that are performed by or in relation to the first device 310, 320. In particular, it is preferred that the first software function is arranged to perform the above-described steps in which transaction information is provided to the first device 310, 320 and where the visually coded information is displayed on the screen display 311, 321.

Similarly, the above-mentioned second software function is preferably executed on or accessible from said second device 410, and the method steps performed in relation to the second device 410, in particular the image capturing, the decoding/interpretation and/or the user confirmation steps are performed by this second software function.

As discussed above, the visually coded information may be plain text, a QR- or bar code, a combination of these alternatives, or any other information which is capable of being decoded and interpreted using digital image analysis after an image has been captured by the second device 410. Hence, the visually coded information must be visually coded in a predetermined way, so that the automatic image analysis can be applied in a predetermined manner, producing repeatable results.

According to a preferred embodiment, the visually coded information discussed above is coded with certain predetermined geometric degrees of freedom, so that the visually coded information can be varied in said degrees of freedom according to a predetermined encoding scheme in such a way so as to encode information carried by such variations. Examples include a QR code, which can be varied with respect to the square pattern of the QR code in order to unambiguously code a particular information; a barcode, the line pattern of which can be varied in a corresponding way; or another piece of graphics which features a variation over time of predetermined principle type, using which particular information is coded.

It is particularly preferred that the visually coded information is provided in the form of a geometric figure, which geometric figure is recognizable to a user as an object which as such in general has no connection to the transaction as such. For instance, the geometric figure can be a general depiction of an animal, a fruit or a plant. Furthermore, it is preferred that the geometric figure is associated with variable geometric degrees of freedom of said type, selected so that said variations do not alter the overall impression of the general type of the object, in other words so that the object does not depict another type of object, as a result of said variations.

Preferred examples of such geometric figures comprise stylized objects, such as a stylized animal or another everyday item.

For instance, if the object is an apple, the information-encoding variations of the apple should not affect the overall impression of the geometric figure depicting “an apple” an nothing else. Such variations can, for instance, be designed so that it is only a field in the interior of an apple shape that changes due to differences in coded information.

It is highly preferred that the visually coded information is coded in a way which is not possible to read without knowing the coding algorithm used, and in particular not readable as plain text or the like to the human eye. In other words, it is preferred that the information is encoded, using variations of the said type, in a way which is machine readable only.

Using such a geometric figure, in particular an easily recognizable geometric figure, as the vehicle for the visually coded information, provides a simple and fast way for the user to immediately recognize the legitimacy of the first device 310, 320 as a first transaction part, effectively preventing phishing attacks by third parties trying to spoof a first device 310, 320.

For instance, the user may select a particular one of a number of predetermined geometric figures, and register the particular one with the user's account, on the central server 100. The central server 100 may then send information regarding what geometric figure to use, or the geometric figure image as such, to the first device 310, 320 for display to the user. Then, the user can verify visually that the selected geometric figure is used on the screen display 311, 321, and can abort the transaction if this is not the case.

The use of such a geometric figure is also an easy and adaptable way of providing a way for individual points of sale to offer a more personalized shopping experience to the user, for instance by implementing commercial messages as a part of the geometric figure.

The image recognition and analysis software used to decode and interpret the captured image must, of course, be informed about how to decode and interpret the visually coded information. This may be done, for instance, by defining several different possible geometric figures in such software, among which the second software function must be able to automatically discriminate; by incorporating as a fixed field in each geometric figure information regarding the type of geometric figure as such; or by displaying a format-defining first geometric figure, as described below, to define the type of figure to be used in a subsequently displayed figure.

In particular, a particular geometric figure, selected from a predetermined set of geometric figures, may be selected on the basis of the type of geometric figure carrying additional information regarding the current state or type of the transaction, or regarding a status of the user or the vendor. For instance, a particular geometric figure may be selected to indicate that a bonus card has been registered with respect to the particular transaction, and another type can be selected as to indicate that a discount applies to the current purchase. This, again, provides a simple yet efficient way of communicating additional and transaction-specific information to the user, which in particular is useful at unmanned points of sale.

In FIG. 2, it is shown how the method comprises a selection of geometric figure before the visually coded information is displayed. As is also shown in this figure, the method may furthermore comprise selecting/displaying several different geometric figures, one after the other.

Such sequences of selected geometric images may reflect the changing states of a transaction, such as when traversing an ordering process at a point of sale, which involves more user selections than a mere “yes” or “no” before the transaction is properly defined. Then, the user can be obliged to capture an image of the screen display 311, 321, plus the piece of hardware mentioned above, after each time the geometric figure changes shape, which effectively proves that the user was actually present during the whole selection process at the physical point of sale.

More generally, it is preferred that the visually coded information comprises an element that changes over time, and that some of the information content of the visually coded information is represented by the said change itself. Then, the image capturing step comprises, as illustrated in FIG. 2, capturing several images of the said type, and the image decoding/interpretation step comprises decoding the series of images so as to detect and interpret said change. The second device 410 may comprise a video recorder, arranged to capture several images per second. Then, the image analysis function may feature a geometric figure change detection means, arranged to determine when the geometric figure changes shape and then capture a still image for decoding/interpretation.

In particular, the change may be selected from the group of geometric shape changes, colour changes and brightness changes, or a combination of any of these. In all of these, and other, cases, it is preferred that the visually coded information comprises both at least one static part and at least one changing part that changes over time. Then, the change of the changing part may encode information regarding a version of the visually coded information. The static part, on the other hand, may then encode payload information regarding the transaction as such.

Moreover, the image may preferably change over time so as to encode a first subset of the visually coded information, after which it encodes a second subset of information. Then the step displaying the visually coded information may comprise concatenating or aggregating the first and second subsets of information in a sequence of changing geometric figures. In particular, it is, in this and other embodiments, preferred that changes made to the visually coded information is repeated on the screen display 311, 321 in a repeating loop, in order to allow the second device 410 to capture the whole sequence by simply directing the (video) camera of the second device 410 towards the screen display 311, 321 and the piece of first device 310, 320 hardware and waiting until a full loop has been traversed.

Hence, in the various ways described above, the visually coded information provides that the transaction identifying information can be automatically and wirelessly communicated to the locally present second device 410, at the same time as the user can be reassured that there are no phishing or other hostile attacks, and at the same time as the user can be provided with meta information regarding the transaction or its progression. A changing geometric figure may also carry more payload information about the transaction than what is possible using a static image, which is particularly useful on small or small-resolution screen displays 311, 321.

In practice, the visually coded information may comprise both the above-discussed plain text regarding the transaction and a changing or static geometric figure such as the ones described above.

Now turning to the visual characteristic/piece of hardware 312, 322 of the first device 310, 320 which is automatically identified based upon the captured image, it is preferred that such identification is performed with respect to all images captured to decode/interpret said visually coded information in case several such images are captured.

Preferably, the identification of said piece of hardware 312, 322 comprises an image analysis step, implemented in the second software function and/or in the central server 100 as described above in relation to the visually coded information, analysing a captured portion of the image covering the piece of hardware 312, 322 in question of the first device 310, 320. This captured portion may be statistically compared to a known geometric shape of a piece of hardware which it is expected that the first device 310, 320 comprises, and/or an image analysis may be performed in which a certain predetermined geometric metric, such as a predetermined geometric relationship or predetermined geometric parameter, is detected by an image analysis function and compared to a corresponding known geometric metric of a piece of hardware which it is expected that the first device 310, 320 comprises.

In this example, it is hence the hardware as such, such as a cover, of the first device 310, 320 which is detected and verified, for instance by detecting a particular shape feature of the cover in question.

However, it is also possible, as an alternative or supplement thereto, that the first device 310, 320 is initially provided with an externally visible and physical add-on feature, and that it is this add-on feature which is detected and interpreted as the piece of hardware in question. Hence, the identification of the piece of hardware may comprise, in the captured image, finding and interpreting a predetermined feature 312, 322 on the first device 310, 320 in the form of a printed or otherwise attached image, such as a QR code, preferably comprising digitally coded information pertaining to the first device 310, 320. Such an image may be in the form of a conventional printed sticker which is initially attached to the second device 410. Preferably, the sticker comprises visually coded information (which is different from the visually coded information discussed above), such as using a QR code, which when decoded/interpreted by the second software function using image analysis software means and communicated to the central server 100, can serve to verify that the first device 310, 320 is indeed authorized by the central server 100 to enter as a first transaction party with respect to a transaction administered by the central server 100. For instance, the visually coded information in said sticker may be a hash value which is provided by the operator of the central server 100 and which is specific to the first device 310, 320 in question, which specificity may be verified only by the central server 100.

Apart from the visually coded information displayed on the screen display 311, 321 and the piece of hardware 312, 322 which is present physically outside of the screen display 311, 321, it is furthermore preferred that the visually coded information displaying method step described above comprises also displaying, on the screen display 311, 321 in question and in addition to said visually coded information, plain text information pertaining to the transaction. This provides a way for the user to verify the contents of the transaction, such as a quantity and a price of a product to purchase, or the name of a service with respect to which a login transaction is to be performed. It is further preferred that the above-described image capturing step comprises that the captured image comprises said plain text information, and that the captured image decoding/interpreting step advantageously also comprises identifying in the captured image said plain text and identifying its textual contents. Then, the information verification step further preferably comprises verifying that the identified plain text information pertaining to the transaction is correct in the sense that it correctly describes the transaction from at least one predetermined point of view. The latter is preferably supported by the plain text information either being formatted in a predetermined way or by it comprising at least one text string which can be used as a queue for the second software function in order to pick transaction information which is to be verified.

In all information verification steps described herein, the verification may be performed by either the second software function or the central server 100, or a combination of the two, such as in a collaborative algorithm. The verification may comprise the comparison between information resulting from an automatic image decoding/interpretation, as described above, to a corresponding expected information. In the case of transaction information, it is preferred that all such transaction information is communicated from the first device 310, 320 or the first transaction party to the central server 100, without passing via the second device 410.

According to one particularly simple and preferred embodiment, the first device 310 is or comprises a card reader terminal 511, and that the plain text mentioned above, apart from the visually coded information, is the same as is conventionally displayed during the performance of a conventional purchase transaction using such a card reader terminal, and in particular that the plain text comprises at least one element comprised in the above discussed visually coded information.

FIGS. 3a-3d show different illustrative first devices 310 during various steps in a method according to the present invention.

In FIG. 3a, the screen display 311 shows the plain text 315 “2 bananas Total: $2.50”. This plain text may be, but is preferably not, part of the above described visually coded information. The visually coded information, on the other hand, is a geometric figure in the form of a depiction of a stylized giraffe 313 with a QR code-like information field 314 in its belly. In this case, it is the QR code-like field 314 which carries the transaction information payload. The visual characteristic/piece of hardware is a QR code 312 on a sticker (or printed directly on the second device 310), for instance providing information identifying the second device 310 as such.

In FIG. 3b, the visual characteristic 312 is instead a characteristic bent edge of the first device 310 hardware cover, for instance being particular to a specific make of a tablet computer used as a cashier by the vendor.

In FIG. 3c, the giraffe geometric figure has made a “jump” upwards on the screen. For instance, this can be to inform the user, before the image is captured, that certain functionality is available at the point of sale, such as the possibility to use a particular loyalty program or the presence of a time-limited campaign. Alternatively, such a “jump” animation can be used after the image has been capture, for instance to indicate to the user that something has happened which is specific to the user and the transaction in question, such as that a user bonus card has been successfully registered for the transaction.

In FIG. 3d, the QR code 314 contents have changed, as well as the plain text field 315 contents, as a result of the registering or detection of the said bonus card.

In FIGS. 3a-3d, the broken lines rectangle 411 illustrates respective exemplifying image views as captured by the second device 410 camera.

The present invention is particularly advantageously applicable in combination with a solution as described in the above referred-to Swedish patent application 1551320-3, wherein the transaction involves the payment of an amount of money using payment card information from a physical payment card such as a bank, credit or debit card. In this case, a physical item is associated to a payment card in an initial initiation step, and then the physical item is used, at a later transaction stage, to authenticate the user to the vendor, and in particular to be able to use the associated payment card as payment means for the transaction.

Herein below, such a method is briefly described. Reference is made to SE 1551320-3 for details.

Hence, such a method is for making an electronic payment, and comprises the following steps, in order:
a) at a first point in time, providing a physical payment card 500 from a first user to a first point of sale 310; inserting the payment card into a physical device 311 of the first point of sale, which device is arranged to electronically read payment card information from the payment card, which card information is sufficient to perform said electronic payment;
b) presenting to the first user an option whether to store the said card information or not;
c) in case the first user responds that the card information is to be stored, identifying the second device 410, or another physical item which is not the payment card and which physical item is held by the user, and associating, in the central server 100, the payment card information with an electronically stored piece of item identifying information identifying the physical item, or another piece of information which in turn is associated with the said piece of item identifying information;
d) at a second, later, point in time, authenticating a second user by a second point of sale 310, 320, which authentication is based upon the said item identifying information; and
e) in case the authentication in step d was successful, performing the electronic payment using the payment card information. This last step is then performed after the above-described verifications, of the visually coded information etc. In this case, the performance of the electronic payment constitutes the performance of the transaction described above.

Step d) is preferably performed when the user is physically present at the point of sale 310, 320, preferably after the transaction has been identified or defined, but at the latest in connection to the verification of the visually coded information etc.

In such a method, the method steps of FIG. 2 are used to authorize the transaction, whereas steps a)-e) are added so as to authenticate the first transaction party (the second user in step d) and to identify the payment card as the payment means to be used in the transaction.

Such a combination provides for a very simple yet extremely powerful and flexible method for performing payments at physical points of sale, in particular in case the second device 410 is the said physical item, without the user having to bring a physical payment card to the point of sale at the time of purchase.

In the following, preferred embodiments of such a combined method are described.

In an initial step, the physical item 410 may have been registered with the central server 100 together with a corresponding piece of item identifying information, and, in step c, the physical item may by identified as the already registered item.

In step d, the item identifying information may be transferred wirelessly from the said physical item 410 to the second point of sale 310, 320, such as using NFC or Bluetooth®. The said wireless transfer may performed with the said physical item 410 being arranged at the most 20 meters from a corresponding physical wireless receiver of the second point of sale 310, 320.

The first user and the second user may one and the same user, namely the user described in connection to FIG. 2. Furthermore, the first point of sale and the second point of sale may one and the same point of sale 310, 320.

In an initial step, the first software function may be configured to cause the payment card reader 311 to do at least one of presenting the option to the user in step c; providing the card information to the central server 100; collecting the item identifying information from the user via an electronic user interface; providing the item identifying information to the central server 100; and authenticating the user at said second point in time.

In step b, the user may also be presented with an option as to for what types of purchases the payment card information is to be used and/or at what points of sale the payment card information is to be used and/or a purchase limit to be associated with the payment card information.

In step d or e, the second point of sale 310, 320 may provide information to the user regarding the amount to be drawn from the payment card 500, and the user may be presented with an option whether or not to confirm the transaction using said amount.

In step e, the second point of sale 310, 320 may use the payment card information to draw a predetermined amount from the payment card 500, without the user being presented with an option whether or not to confirm the transaction using said amount, which predetermined amount is associated with the payment card information in the central server 100.

The item identifying information may comprise an MSISDN or IMSI code of the mobile device 410 controlled by the user, and the authentication in step d may comprise the central server 100 or the second point of sale 310, 320 interacting with said mobile device 410 identified using said MSISDN or IMSI code.

The authentication in step d may comprise sending an SMS message to the mobile device 410 with a code, which code is then provided to the second point of sale 310, 320 or to the central server 100.

The authentication in step d may comprise the second point of sale 310, 320 or the central server 100 electronically interacting with the second software function and securely tying the mobile device 410 to the user, which interaction may comprise a step in which the user interacts with the mobile device 410, and which interaction securely identifies the mobile device 410 and the occurrence of said user interaction step to the second point of sale 310, 320 or the central server 100.

The item identifying information may be automatically transferred to the first point of sale 310 using a wireless communication, such as a nearfield wireless transmission, and the authentication in step d may comprise transferring said item identifying information to the second point of sale 310, 320 and verifying the information received.

Account information, identifying a money account of the user, may be registered in the central server 100, step c may comprise associating the money account to the payment card information in the central server 100, the user may be allowed to select a certain threshold value of the money on said money account, and a transfer of funds may be arranged to automatically be performed from said payment card to said money account when the balance of the money account falls below the said threshold.

The user may be allowed to register several pieces of item identifying information for one and the same payment card 500, wherein different such pieces of item identifying information are associated with the same or different users, and such registered pieces of item identifying information may be associated with one and the same card information in the central server 100 upon such registration.

The user interface 120 may be arranged to allow the user to remotely administer the various types of information stored in the central server 100 and/or associated therein to the payment card information.

Above, preferred embodiments have been described. However, it is apparent to the skilled person that many modifications can be made to the disclosed embodiments without dew parting from the basic idea of the invention.

For instance, many different points of sale and many different users may of course be served by one and the same central server 100.

A further example is that the central server may be arranged to identify skimming equipment, based upon predetermined information regarding specific known such pieces of skimming equipment or known visual indicators of such skimming equipment. Then, the central server may, as a part of the image analysis step described above, analyse the captured image with the aim of detecting any such skimming equipment on the first device 310, 320, and, if such equipment is detected, send an alarm to the vendor.

In general, the respective features of all embodiments described herein can be combined in any way, as applicable. The embodiments are merely intended to illustrate various aspects of the invention, which aspects are hence in general freely combinable.

Hence, the invention is not limited to the described embodiments, but can be varied within the scope of the enclosed claims.

1. Method for authenticating a transaction, wherein a first transaction party uses a first electronic device for performing said transaction and a second transaction party uses a second, portable, electronic device for performing said transaction, which first device comprises a screen display and which second device is a general-purpose programmable device comprising a digital camera, wherein the method comprises the steps of:
a) associating, in a central server, the transaction with the first device and providing, to the first device, information regarding the transaction;
b) displaying, on the screen display, visually coded information identifying the transaction;
c) capturing, using the digital camera, an image of the screen display, which image comprises said visually coded information as well as at least a portion of the first device which portion lies outside of the screen display;
d) decoding and interpreting said visually coded information, based on the captured image, and further identifying, using image analysis, a geometric shape or metric of a piece of hardware pertaining to the first device also based upon the same captured image;
e) sending information comprising or corresponding to, the visually coded information and the identified piece of hardware to the central server for verification, or alternatively that information corresponding to or comprising the said captured image is sent to the central server for interpretation and verification; and
f) verifying that the transaction identified by the visually coded information is associated with the first device, based upon the identified piece of hardware.

2. (canceled)

3. Method according to claim 2, wherein the second device allows the second party to confirm transaction information on a screen display comprised in the second device before the transaction is finally authorized.

4. Method according to claim 3, wherein the transaction information to be verified is sent from the first device to the central server and thereafter from the central server to the second device before said transaction information confirmation.

5. Method according to claim 1, wherein, before step e is performed, the second transaction party is identified using the second device.

6. Method according to claim 5, wherein the transaction is adjusted, such as in terms of price to be paid; payment method to use; or points to be awarded a customer loyalty program as a consequence of a purchase, before step e is performed, and in which the said confirmation is performed with respect to the adjusted transaction.

7. Method according to claim 5, wherein the central server, based upon said identification of the second transaction party and previously stored information relating to the second transaction party available to the central server, verifies that the second transaction party is entitled to take part in the transaction using the first electronic device and/or in relation to the first transaction party.

8. Method according to claim 1, wherein the visually coded information is coded with certain predetermined geometric degrees of freedom, so that the visually coded information can be varied in said degrees of freedom according to a predetermined encoding scheme in such a way so as to encode information carried by such variations.

9. Method according to claim 8, wherein the visually coded information (313) is provided in the form of a geometric figure, which geometric figure is recognizable to a user as an object which as such has no connection to the transaction as such, and which geometric degrees of freedom are selected so that said variations do not alter the overall impression of the type of the object, hence so that the object does not depict another type of object, as a result thereof.

10. Method according to claim 8, wherein the visually coded information comprises at least one of a transaction identifier; information describing the subject of the transaction; a time stamp; a random/cryptographic key; and a device identifier.

11. Method according to claim 8, wherein step b comprises selecting one geometric figure from a predetermined set of such figures, so that the type of geometric figure carries additional information regarding the current state of the transaction, such as that a bonus card has been registered with respect to the transaction.

12. Method according to claim 1, wherein the visually coded information comprises an element that changes over time, wherein some of the information content of the visually coded information is represented by the said change itself, wherein step c comprises capturing several images of the said type, and wherein step d comprises decoding the series of images so as to detect and interpret said change.

13. Method according to claim 12, wherein the visually coded information (313) comprises both at least one static part and at least one changing part that changes over time, wherein the change of the changing part encodes information regarding a version of the visually coded information.

14. Method according to claim 13, wherein the static part encodes payload information regarding the transaction.

15. Method according to claim 1, wherein the identification of said piece of hardware comprises an image analysis in which the captured portion in said image is compared to a known geometric shape of a piece of hardware which it is expected that the first device comprises, or an image analysis in which a certain predetermined geometric metric is detected by an image analysis and compared to a corresponding known geometric metric of a piece of hardware which it is expected that the first device comprises.

16. Method according to claim 1, the identification of said piece of hardware comprises finding and interpreting a predetermined feature on the first device in the form of a printed or attached image, such as a QR code, said feature comprising digitally coded information pertaining to the first device.

17. Method according to claim 1, wherein step b further comprises displaying, on the screen display of said first device, plain text information pertaining to the transaction, wherein step c further comprises that the captured image comprises said plain text information, wherein in that step d comprises identifying in the captured image said plain text and identifying its textual contents, and wherein step e further comprises verifying that the identified plain text information pertaining to the transaction is correct in the sense that it correctly describes the transaction from at least one predetermined point of view.

18. Method according to claim 17, wherein the first device is or comprises a card reader terminal, and wherein the plain text information is the same as is conventionally displayed in a conventional purchase using such a card reader terminal, and in particular that the plain text information comprises at least one element comprised in the information provided in step a.

19. Method according to claim 1, wherein the transaction comprises the electronic payment of an amount of money, which method further comprises the steps:
at a first point in time, providing a physical payment card from a first user to a first point of sale; inserting the payment card into a physical device of the first point of sale, which device is arranged to electronically read payment card information from the payment card, which card information is sufficient to perform said electronic payment;
identifying the second device, or another physical item which is not the payment card and which physical item is held by the first user, and associating, in a central server, the payment card information with an electronically stored piece of item-identifying information identifying the physical item in question, or another piece of information which in turn is associated with the said piece of item-identifying information;
at a second, later, point in time, authenticating the user by the first device, which authentication is based upon the said item identifying information; and
after step e), and in case the said authentication was successful, performing the electronic payment using the payment card information.

20. System for authenticating a transaction, wherein a first transaction party uses a first electronic device for performing said transaction and a second transaction party uses a second, portable, electronic device for performing said transaction, which first device comprises a screen display and which second device is a general-purpose programmable device comprising a digital camera, which system comprises a first transaction software function arranged to be executed on or from the first device or a control device arranged to control the screen display; a second transaction software function arranged to be executed on or from the second device; and a central server in communication with said first and second software functions, wherein the central server is arranged to associate the transaction with the first device; and wherein the first software function is arranged to display, on the screen display, visually coded information identifying the transaction, wherein characterised in that in that the second software function is arranged to capture, using the digital camera, an image of the screen display, which image comprises said visually coded information as well as at least a portion of the first device which portion lies outside of the screen display; wherein that the second software function and/or the central server is arranged to decode and interpret said visually coded information, based on the captured image, and further to identify, using image analysis, a geometric shape or metric of a piece of hardware pertaining to the first device also based upon the same captured imaged; and wherein the central server is arranged to verify that the transaction identified by the visually coded information is associated with the first device, based upon the identified piece of hardware.
